(19) United States
(12) Patent Application Publication
(10) Pub. No.: US 2017/0127450 A1
(43) Pub. Date: May 4, 2017

(54) DATA TRANSMISSION CONTROL METHOD AND DEVICE

(71) Applicant: HUAWEI TECHNOLOGIES CO., LTD., Shenzhen (CN)

(72) Inventors: Jun LUO, Shanghai (CN); Chixiang MA, Shanghai (CN); Yingpei LIN, Shanghai (CN)

(73) Assignee: HUAWEI TECHNOLOGIES CO., LTD., Shenzhen (CN)

(21) Appl. No.: 15/408,968

(22) Filed: Jan. 18, 2017

Related U.S. Application Data
(63) Continuation of application No. PCT/CN2014/082882, filed on Jul. 24, 2014.

(51) Int. Cl. H04W 74/08; H04L 12/26; H04L 12/707; H04B 17/336

(52) U.S. Cl. CPC H04W 74/0816; H04B 17/336; H04L 43/0888; H04L 45/24

(57) ABSTRACT

The present application provides a data transmission control method and device. The method includes: obtaining a first signal to interference plus noise ratio during serial data transmission performed by a sending node on a potential link, and obtaining a second signal to interference plus noise ratio during serial data transmission on each existing link that causes interference to the potential link; calculating, according to the first signal to interference plus noise ratio and all the second signal to interference plus noise ratios, a first system throughput during the serial data transmission performed by the sending node on the potential link and a second system throughput during parallel data transmission performed by the sending node on the potential link; and controlling, according to the first system throughput and the second system throughput, whether the sending node performs the parallel data transmission on the potential link.

### CROSS-REFERENCE TO RELATED APPLICATIONS

This application is a continuation of International Application No. PCT/CN2014/082882, filed on Jul. 24, 2014, the disclosure of which is hereby incorporated by reference in its entirety.

### TECHNICAL FIELD

The present application relates to the field of wireless communications technologies, and in particular, to a data transmission control method and device.

### BACKGROUND

With development of mobile Internet and popularization of intelligent terminals, a WLAN (Wireless Local area Network) becomes a currently widespread mobile broadband access technology by virtue of advantages such as a high rate and low costs. In addition, with popularization of the WLAN technology, how to transmit data after accessing a WLAN system becomes one of problems that need to be resolved in the WLAN technology.

In the prior art, a CSMA/CA (Carrier Sense Multiple Access/Collision Avoidance) contention mechanism is generally used at a MAC (Media Access Control) layer of a WLAN to transmit data. A sending node performs carrier sensing before sending data. If it is detected that energy of a current channel exceeds a CCA (Clear Channel Assessment) threshold, the sending node does not send the data. If it is detected that energy of a current channel is lower than the CCA threshold, the sending node performs channel contention. The mechanism essentially pertains to serial data transmission without interference (data is being transmitted on only one link within a carrier sensing range at a same time point).

In a parallel data transmission method (data is being transmitted on multiple links within a carrier sensing range at a same time point), a parallel transmission link is added by sacrificing data transmission quality of links at a single node and introducing interference between adjacent links. An existing communications system using the parallel data transmission method is based on good network planning and coverage estimation, and has a better system gain. However, because of a lack of network planning in a WLAN system, there is a dense networking form with a larger overlapped coverage area, resulting in greater interference between nodes (including an access point and a station) and more interference sources. Consequently, a throughput during transmission may be reduced when this parallel data transmission method is used in the WLAN system.

### SUMMARY

To resolve a problem in the prior art, embodiments of the present application provide a data transmission control method and device. Technical solutions are as follows:

According to a first aspect, a data transmission control method is provided, and the method includes:

obtaining a first signal to interference plus noise ratio during serial data transmission performed by a sending node on a potential link, and obtaining a second signal to interference plus noise ratio during serial data transmission on each existing link that causes interference to the potential link;

calculating, according to the first signal to interference plus noise ratio and all the second signal to interference plus noise ratios, a first system throughput during the serial data transmission performed by the sending node on the potential link, and calculating, according to the first signal to interference plus noise ratio and all the second signal to interference plus noise ratios, a second system throughput during parallel data transmission performed by the sending node on the potential link; and controlling, according to the first system throughput and the second system throughput, whether the sending node performs the parallel data transmission on the potential link.

With reference to the first aspect, in a first possible implementation manner of the first aspect, the obtaining a first signal to interference plus noise ratio during serial data transmission performed by a sending node on a potential link includes:

obtaining, according to a management frame broadcast by a potential receiving node on the potential link, the first signal to interference plus noise ratio during the serial data transmission performed by the sending node on the potential link; and

the obtaining a second signal to interference plus noise ratio during serial data transmission on each existing link that causes interference to the potential link includes:

obtaining, according to a management frame broadcast by a receiving node on each existing link that causes interference to the potential link, the second signal to interference plus noise ratio during the serial data transmission on each existing link that causes interference to the potential link.

With reference to the first possible implementation manner of the first aspect, in a second possible implementation manner of the first aspect, the method further includes:

receiving, at preset time intervals, a management frame broadcast by each node in a system, where the management frame carries signal to interference plus noise ratio information of a link on which the node is located.

With reference to the first aspect, in a third possible implementation manner of the first aspect, the controlling, according to the first system throughput and the second system throughput, whether the sending node performs the parallel data transmission on the potential link includes:

comparing the first system throughput with the second system throughput; and

controlling the sending node to perform the parallel data transmission on the potential link if the second system throughput is greater than the first system throughput.

With reference to the third possible implementation manner of the first aspect, in a four possible implementation manner of the first aspect, if the second system throughput is greater than the first system throughput, the method further includes:

increasing a clear channel assessment CCA threshold; and

the controlling the sending node to perform the parallel data transmission on the potential link includes:

controlling the sending node to perform the parallel data transmission on the potential link if energy of a current channel is lower than an increased CCA threshold.

With reference to any one of the first aspect, or the first to the fourth possible implementation manners of the first aspect, in a fifth possible implementation manner of the first aspect, the potential link and the existing links are data links in an entire transmission bandwidth, or the potential link and the existing links are data links in a transmission sub-bandwidth of an entire transmission bandwidth.

According to a second aspect, a data transmission control method is provided, and the method includes:

obtaining a signal to interference plus noise ratio during serial data transmission on an existing link; and

broadcasting a management frame in a preset cycle, where the management frame carries the signal to interference plus noise ratio during the serial data transmission on the existing link, so that a data transmission control device controls, according to the signal to interference plus noise ratio carried in the management frame, whether the sending node performs parallel data transmission on the potential link.

With reference to the second aspect, in a first possible implementation manner of the second aspect, the potential link and the existing link are data links in an entire transmission bandwidth, or the potential link and the existing link are data links in a transmission sub-bandwidth of an entire transmission bandwidth.

According to a third aspect, a data transmission control device is provided, and the device includes:

a first obtaining module, configured to obtain a first signal to interference plus noise ratio during serial data transmission performed by a sending node on a potential link;

a second obtaining module, configured to obtain a second signal to interference plus noise ratio during serial data transmission on each existing link that causes interference to the potential link;

a first calculation module, configured to calculate, according to the first signal to interference plus noise ratio and all the second signal to interference plus noise ratios, a first system throughput during the serial data transmission performed by the sending node on the potential link;

a second calculation module, configured to calculate, according to the first signal to interference plus noise ratio and all the second signal to interference plus noise ratios, a second system throughput during parallel data transmission performed by the sending node on the potential link; and
a control module, configured to control, according to the first system throughput and the second system throughput, whether the sending node performs the parallel data transmission on the potential link.

With reference to the third aspect, in a first possible implementation manner of the third aspect, the first obtaining module is configured to obtain, according to a management frame broadcast by a potential receiving node on the potential link, the first signal to interference plus noise ratio during the serial data transmission performed by the sending node on the potential link; and the second obtaining module is configured to obtain, according to a management frame broadcast by a receiving node on each existing link that causes interference to the potential link, the second signal to interference plus noise ratio during the serial data transmission on each existing link that causes interference to the potential link.

With reference to the first possible implementation manner of the third aspect, in a second possible implementation manner of the third aspect, the device further includes:

a receiving module, configured to receive, at preset time intervals, a management frame broadcast by each node in a system, where the management frame carries signal to interference plus noise ratio information of a link on which the node is located.

With reference to the third aspect, in a third possible implementation manner of the third aspect, the control module includes:

a comparison unit, configured to compare the first system throughput with the second system throughput; and

a control unit, configured to control the sending node to perform the parallel data transmission on the potential link when the second system throughput is greater than the first system throughput.

With reference to the third possible implementation manner of the third aspect, in a fourth possible implementation manner of the third aspect, the device further includes:

an adjustment module, configured to increase a CCA threshold; and

the control unit is configured to control the sending node to perform the parallel data transmission on the potential link when energy of a current channel is lower than an increased CCA threshold.

With reference to any one of the third aspect, or the first to the fourth possible implementation manners of the third aspect, in a fifth possible implementation manner of the third aspect, the potential link and the existing links are data links in an entire transmission bandwidth, or the potential link and the existing links are data links in a transmission sub-bandwidth of an entire transmission bandwidth.

According to a fourth aspect, a data transmission device is provided, and the device includes:

an obtaining module, configured to obtain a signal to interference plus noise ratio during serial data transmission on an existing link; and

a broadcast module, configured to broadcast a management frame in a preset cycle, where the management frame carries the signal to interference plus noise ratio during the serial data transmission on the existing link, so that a data transmission control device controls, according to the signal to interference plus noise ratio carried in the management frame, whether the sending node performs parallel data transmission on the potential link.

With reference to the fourth aspect, in a first possible implementation manner of the fourth aspect, the potential link and the existing link are data links in an entire transmission bandwidth, or the potential link and the existing link are data links in a transmission sub-bandwidth of an entire transmission bandwidth.

The technical solutions provided in the embodiments of the present application bring the following beneficial effects:

A first system throughput during serial data transmission performed by a sending node on a potential link and a second system throughput during parallel data transmission performed by the sending node on the potential link are calculated according to a first signal to interference plus noise ratio during the serial data transmission performed by the sending node on the potential link and a second signal to interference plus noise ratio during serial data transmission on each existing link that causes interference to the potential link, and then whether the sending node performs the parallel data transmission on the potential link is controlled according to the first system throughput and the second system throughput, thereby ensuring a link throughput.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a flowchart of a data transmission control method according to an embodiment of the present application;

FIG. 2 is a flowchart of a data transmission control method according to another embodiment of the present application;

FIG. 3 is a schematic diagram of node distribution according to another embodiment of the present application;

FIG. 4 is a flowchart of a data transmission control method according to another embodiment of the present application;

FIG. 5 is a schematic structural diagram of a data transmission control device according to another embodiment of the present application;

FIG. 6 is a schematic structural diagram of a data transmission control device according to another embodiment of the present application;

FIG. 7 is a schematic structural diagram of a control module according to another embodiment of the present application;

FIG. 8 is a schematic structural diagram of a data transmission control device according to another embodiment of the present application;

FIG. 9 is a schematic structural diagram of a data transmission device according to another embodiment of the present application;

FIG. 10 is a schematic structural diagram of a data transmission device according to another embodiment of the present application; and

FIG. 11 is a schematic structural diagram of a data transmission device according to another embodiment of the present application.

### DESCRIPTION OF EMBODIMENTS

To make the objectives, technical solutions, and advantages of the present application clearer, the following further describes the embodiments of the present application in detail with reference to the accompanying drawings.

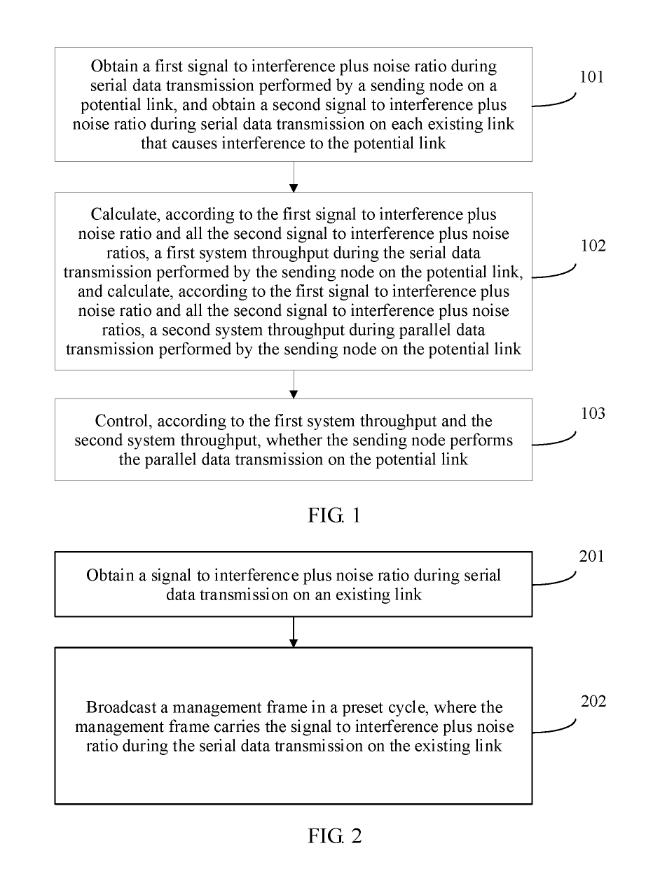

An embodiment of the present application provides a data transmission control method. The data transmission control method is applied to a data transmission system, and the data transmission system includes at least one sending node and at least one receiving node. To determine, while ensuring system throughput, whether to control a sending node to perform parallel data transmission, a perspective of controlling whether a sending node that is to send data on a potential link performs parallel data transmission is used as an example in this embodiment, to describe the method provided in this embodiment. As shown in FIG. 1, the method includes the following steps:

101. Obtain a first signal to interference plus noise ratio during serial data transmission performed by the sending node on a potential link, and obtain a second signal to interference plus noise ratio during serial data transmission on each existing link that causes interference to the potential link.

102. Calculate, according to the first signal to interference plus noise ratio and all the second signal to interference plus noise ratios, a first system throughput during the serial data transmission performed by the sending node on the potential link, and calculate, according to the first signal to interference plus noise ratio and all the second signal to interference plus noise ratios, a second system throughput during parallel data transmission performed by the sending node on the potential link.

103. Control, according to the first system throughput and the second system throughput, whether the sending node performs the parallel data transmission on the potential link.

A perspective of a receiving node in the system is used as an example. As shown in FIG. 2, the method includes the following steps:

201. Obtain a signal to interference plus noise ratio during serial data transmission on an existing link.

202. Broadcast a management frame in a preset cycle, where the management frame carries the signal to interference plus noise ratio during the serial data transmission on the existing link, so that a data transmission control device controls, according to the signal to interference plus noise ratio carried in the management frame, whether the sending node performs parallel data transmission on the potential link.

According to the method provided in this embodiment of the present application, a first system throughput during serial data transmission performed by a sending node on a potential link and a second system throughput during parallel data transmission performed by the sending node on the potential link are calculated according to a first signal to interference plus noise ratio during the serial data transmission performed by the sending node on the potential link and a second signal to interference plus noise ratio during serial data transmission on each existing link that causes interference to the potential link, and then whether the sending node performs the parallel data transmission on the potential link is controlled according to the first system throughput and the second system throughput, thereby performing the parallel data transmission while ensuring a link throughput.

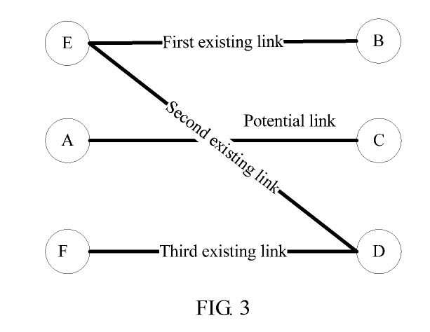

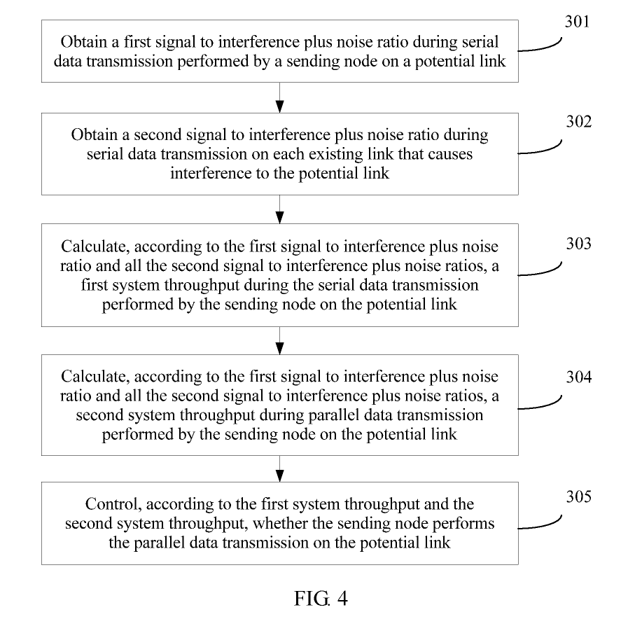

To make a person skilled in the art more clearly understand the technical solutions provided in the embodiments of the present application, a data transmission control method is described in detail in the following by using a specific embodiment. In this embodiment, a sending node may be an AP (Access Point) or a STA (Station), and a receiving node may also be an AP or a STA. For ease of description, for example, in an architectural diagram shown in FIG. 3, a potential link is a link between a node A and a node C, the node A is used as a potential sending node, the node C is used as a potential receiving node, existing links include a first existing link, a second existing link, and a third existing link, the first existing link is a link between a node E and a node B, the second existing link is a link between the node E and a node D, and the third existing link is a link between a node F and the node D. The potential link is a link on which data has not been transmitted. During control over whether the sending node A on the potential link performs parallel data transmission to the receiving node C, because the existing links cause interference to the potential link, whether to control the sending node A on the potential link to perform the parallel data transmission to the potential receiving node C is determined according to a change in a system throughput. As shown in FIG. 4, the method includes the following steps.

301. Obtain a first signal to interference plus noise ratio during serial data transmission performed by a sending node on a potential link.

A manner for obtaining the first signal to interference plus noise ratio during the serial data transmission performed by the sending node on the potential link is not limited in this embodiment. In specific implementation, each node in a system can broadcast, in a preset cycle, a management frame carrying a signal to interference plus noise ratio during serial data transmission on an existing link. Therefore, before the first signal to interference plus noise ratio during the serial data transmission performed by the sending node on the potential link is obtained, the management frame broadcast by each node in the system may be received. In addition, because a signal to interference plus noise ratio of a link on which each node is located is carried in the management frame, the first signal to interference plus noise ratio during the serial data transmission performed by the sending node on the potential link may be obtained according to a management frame broadcast by a potential receiving node on the potential link.

A length of the preset cycle is not limited in this embodiment, and may be specifically set according to an actual situation. In addition, the management frame may be an ISF (Interference Strength Frame). The signal to interference plus noise ratio carried in the management frame may be a signal to interference plus noise ratio during serial data transmission on the existing link in the preset cycle. In an optional embodiment, to obtain a more accurate signal to interference plus noise ratio, interference noise statistics may be further carried in the management frame, and the interference noise statistics may include but is not limited to an interference amount, an interference to noise ratio, and the like. Content carried in the management frame and a specific structure of the management frame are not limited in this embodiment.

An existing link W is used as an example, and content and a structure of the management frame may include but are not limited to table 1:

TABLE 1

| | |
|---|---|
| SINR_W | I_N_W |

In table 1, SINR_W is a signal to interference plus noise ratio during serial data transmission on the existing link W, and I_N_W is interference noise item statistics during the serial data transmission on the existing link W.

Further, a manner for obtaining, according to the management frame broadcast by the potential receiving node on the potential link, the first signal to interference plus noise ratio during the serial data transmission performed by the sending node on the potential link is not specifically limited in this embodiment. A system shown in FIG. 3 is used as an example. A first signal to interference plus noise ratio during serial data transmission performed by the sending node A on the potential link may be obtained according to a management frame broadcast by the potential receiving node C on the potential link. Because the potential link is a link on which data has not been transmitted, the first signal to interference plus noise ratio that is during the serial data transmission performed by the sending node on the potential link and that is obtained according to the management frame broadcast by the potential receiving node on the potential link is only a prediction result, and the obtaining manner includes but is not limited to any one of the following two manners.

In a first manner, the first signal to interference plus noise ratio during the serial data transmission performed by the sending node on the potential link is obtained according to a signal to interference plus noise ratio carried in a management frame broadcast by the potential receiving node on the potential link in a previous preset cycle.

For example, the first signal to interference plus noise ratio during the serial data transmission performed by the sending node on the potential link is obtained according to the signal to interference plus noise ratio carried in the management frame broadcast by the potential receiving node on the potential link in the previous preset cycle, and is obtained according to the following formula:

$${SINR}_{A}^{′} = \frac{{SINR}_{A} * ( I + \tilde{N} )}{I + \tilde{N} + {I}_{A}} ,$$

where SINR′_{A} indicates the first signal to interference plus noise ratio that is during the serial data transmission performed by the sending node A on the potential link and that is calculated in the first manner, SINR_{A} indicates the signal to interference plus noise ratio carried in the management frame broadcast by the potential receiving node on the potential link in the previous preset cycle, I indicates an interference amount during the serial data transmission performed by the sending node A on the potential link, Ñ indicates a noise amount during the serial data transmission performed by the sending node A on the potential link, and I_{A} indicates an external interference amount. Manners for obtaining I, Ñ, and I_{A} are not limited in this embodiment. In specific implementation, interference noise statistics may be further carried in the management frame, and the interference noise statistics may include but are not limited to an interference amount, an interference to noise ratio, and the like. Therefore, I, Ñ, and I_{A} may be obtained according to the interference noise statistics carried in the management frame.

In a second manner, the first signal to interference plus noise ratio during the serial data transmission performed by the sending node on the potential link is obtained according to an average value of signal to interference plus noise ratios carried in management frames broadcast by the potential receiving node on the potential link in a preset quantity of previous preset cycles.

For example, the first signal to interference plus noise ratio during the serial data transmission performed by the sending node on the potential link is obtained according to the average value of the signal to interference plus noise ratio information carried in the management frames broadcast by the potential receiving node on the potential link in the preset quantity of previous preset cycles, and is obtained according to the following formula:

$${SINR}_{{A}^{′}}^{′} = \frac{{SINR}_{\overline{A}} * ( I + \tilde{N} )}{I + \tilde{N} + {I}_{A}} ,$$

where SINR′_{A′} indicates the first signal to interference plus noise ratio that is during the serial data transmission performed by the sending node A on the potential link and that is calculated in the second manner, SINR_{Ā}indicates the average value of the signal to interference plus noise ratio information carried in the management frames broadcast by the potential receiving node on the potential link in the preset quantity of previous preset cycles, I indicates an interference amount during the serial data transmission performed by the sending node A on the potential link, Ñ indicates a noise amount during the serial data transmission performed by the sending node A on the potential link, and I_{A} indicates an external interference amount. Manners for obtaining I, Ñ, and I_{A} are not limited in this embodiment.

In specific implementation, interference noise statistics may be further carried in each management frame, and the interference noise statistics may include but are not limited to an interference amount, an interference to noise ratio, and the like. Therefore, I, Ñ, and I_{A} may be obtained according to an average value of the interference noise statistics carried in the management frames.

302. Obtain a second signal to interference plus noise ratio during serial data transmission on each existing link that causes interference to the potential link.

A manner for obtaining the second signal to interference plus noise ratio during the serial data transmission on each existing link that causes interference to the potential link is not specifically limited in this embodiment either. It can be learned from content of step 301 that each node in the system can broadcast, in the preset cycle, the management frame carrying the signal to interference plus noise ratio during the serial data transmission on the existing link, a data transmission control device in this embodiment can receive the management frame broadcast by each node in the system, and the management frame carries the signal to interference plus noise ratio of each link on which the node is located. Therefore, the second signal to interference plus noise ratio during the serial data transmission on each existing link that causes interference to the potential link may be obtained according to a management frame broadcast by a receiving node on each existing link that causes interference to the potential link. A specific obtaining principle is the same as the principle for obtaining the first signal to interference plus noise ratio in step 301, and details are not described herein again.

In the system shown in FIG. 3, because the existing links that cause interference to the potential link include the first existing link, the second existing link, and the third existing link, the second signal to interference plus noise ratio during the serial data transmission on each existing link that causes interference to the potential link may be obtained by receiving management frames sent by nodes on these three existing links.

303. Calculate, according to the first signal to interference plus noise ratio and all the second signal to interference plus noise ratios, a first system throughput during the serial data transmission performed by the sending node on the potential link.

A manner for calculating, according to the first signal to interference plus noise ratio and all the second signal to interference plus noise ratios, the first system throughput during the serial data transmission performed by the sending node on the potential link is not specifically limited in this embodiment, and includes but is not limited to the following two manners.

In a first manner, a throughput during the serial data transmission on the potential link and the serial data transmission on each existing link is calculated according to the first signal to interference plus noise ratio and all the second signal to interference plus noise ratios, and then all the obtained throughputs are added to obtain the first system throughput during the serial data transmission performed by the sending node on the potential link.

When the throughput during the serial data transmission on the potential link and the serial data transmission on each existing link is calculated according to the first signal to interference plus noise ratio and all the second signal to interference plus noise ratios, the manner includes but is not limited to calculation according to the following formula:

Cₛ½ log₂(1+SINR₋ₐᵥₑᵣ₋₁)+½ log₂(1+SINR₋ₐᵥₑᵣ₋₂),

where Cₛ is a throughput during the serial data transmission on the potential link and serial data transmission on one existing link SINR₋ₐᵥₑᵣ₋₁ is the first signal to interference plus noise ratio during the serial data transmission on the potential link, and SINR₋ₐᵥₑᵣ₋₂ is a second signal to interference plus noise ratio during serial data transmission on one of existing links.

The throughput during the serial data transmission on the potential link and the serial data transmission on each existing link is calculated according to the foregoing manner, and then all the obtained throughputs are added to obtain the first system throughput during the serial data transmission performed by the sending node on the potential link.

In a second manner: a throughput during the serial data transmission on the potential link and serial data transmission on all the existing links is calculated according to the first signal to interference plus noise ratio and all the second signal to interference plus noise ratios, to obtain the first system throughput.

When the throughput during the serial data transmission on the potential link and the serial data transmission on all the existing links is calculated according to the first signal to interference plus noise ratio and all the second signal to interference plus noise ratios, the manner includes but is not limited to calculation according to the following formula:

$${C}_{s}^{′} \approx \frac{1}{N} Σ [ {log}_{2} ( 1 + {SINR}_{- aver - 1} ) + {log}_{2} ( 1 + {SINR}_{- aver - 2} ) + ⋯ + {log}_{2} ( 1 + {SINR}_{- aver - N} ) ] ,$$

where Cₛ is the throughput during the serial data transmission on the potential link and the serial data transmission on all the existing links, that is, the first system throughput, and N is a quantity of links. In the system shown in FIG. 3, because there is one potential link and three existing links, N is 4. SINR₋ₐᵥₑᵣ₋₁ is the first signal to interference plus noise ratio during the serial data transmission on the potential link SINR₋ₐᵥₑᵣ₋₂ is a second signal to interference plus noise ratio during serial data transmission on one of the existing links, and SINR_{-aver-N} is an Nₜₕ signal to interference plus noise ratio during serial data transmission on one of the existing links.

304. Calculate, according to the first signal to interference plus noise ratio and all the second signal to interference plus noise ratios, a second system throughput during parallel data transmission performed by the sending node on the potential link.

A manner for calculating, according to the first signal to interference plus noise ratio and all the second signal to interference plus noise ratios, the second system throughput during the parallel data transmission performed by the sending node on the potential link is not specifically limited in this embodiment. Corresponding to the manner for calculating the first system throughput in step 303, the manner for calculating the second system throughput in step 304 also includes but is not limited to the following two manners.

In a first manner, a throughput during the parallel data transmission on the potential link and parallel data transmission on each existing link is calculated according to the first signal to interference plus noise ratio and all the second signal to interference plus noise ratios, and then all the obtained throughputs are added to obtain the second system throughput during the parallel data transmission performed by the sending node on the potential link.

When the throughput during the parallel data transmission on the potential link and the parallel data transmission on each existing link is calculated according to the first signal to interference plus noise ratio and all the second signal to interference plus noise ratios, the manner includes but is not limited to calculation according to the following formula:

C_{P}≈log₂(1+SINR_{aver 1})+log₂(1+SINR_{aver 2}),

where C_{P} is a throughput during the parallel data transmission on the potential link and parallel data transmission on one existing link SINR₋₋ₐᵥₑᵣ₋₁ is the first signal to interference plus noise ratio during the serial data transmission on the potential link, and SINR₋ₐᵥₑᵣ₋₂ is a second signal to interference plus noise ratio during serial data transmission on one of existing links.

In a second manner, a throughput during the parallel data transmission on the potential link and parallel data transmission on all the existing links is calculated according to the first signal to interference plus noise ratio and all the second signal to interference plus noise ratios, to obtain the second system throughput.

When the throughput during the parallel data transmission on the potential link and the parallel data transmission on all the existing links is calculated according to the first signal to interference plus noise ratio and all the second signal to interference plus noise ratios, the manner includes but is not limited to calculation according to the following formula:

$${C}_{p}^{′} \approx {Σ}^{N} [ {log}_{2} ( 1 + {SINR}_{- aver - 1} ) + {log}_{2} ( 1 + {SINR}_{- aver - 2} ) + ⋯ + {log}_{2} ( 1 + {SINR}_{- aver - 2} ) ] ,$$

where C_{P} is the throughput during the parallel data transmission on the potential link and the parallel data transmission on all the existing links, that is, the second system throughput, and N is a quantity of links. In the system shown in FIG. 3, because there is one potential link and three existing links, N is 4. SINR₋ₐᵥₑᵣ₋₁ is the first signal to interference plus noise ratio during the serial data transmission on the potential link SINR₋ₐᵥₑᵣ₋₂ is a second signal to interference plus noise ratio during serial data transmission on one of the existing links, and SINR_{-aver-N} is a second signal to interference plus noise ratio during serial data transmission on one of the existing links.

305. Control, according to the first system throughput and the second system throughput, whether the sending node performs the parallel data transmission on the potential link.

A manner for controlling, according to the first system throughput and the second system throughput, whether the sending node performs the parallel data transmission on the potential link is not specifically limited in this embodiment either, and includes but is not limited to: comparing the first system throughput with the second system throughput, and if the second system throughput is greater than or equal to the first system throughput, controlling the sending node to perform the parallel data transmission on the potential link. If the second system throughput is less than the first system throughput, the sending node is controlled to perform the serial data transmission on the potential link.

In an optional embodiment, if the second system throughput is greater than the first system throughput, the method provided in this embodiment further includes: increasing a CCA threshold.

The controlling the sending node to perform the parallel data transmission on the potential link includes:

controlling the sending node to perform the parallel data transmission on the potential link if energy of a current channel is lower than an increased CCA threshold.

For a manner for increasing the CCA threshold, in specific implementation, each time the second system throughput is determined greater than the first system throughput, the CCA threshold may be increased by an equal difference. For example, each time the second system throughput is determined greater than the first system throughput, the CCA threshold is increased by 10 dBm (decibel-millivolt) at a time. In addition to the manner for increasing the CCA threshold by an equal difference, the CCA threshold may further be increased by a variable difference. For example, after the second system throughput is determined greater than the first system throughput for the first time, the CCA threshold is increased by 6 dBm; after the second system throughput is determined greater than the first system throughput for the second time, the CCA threshold is increased by 8 dBm; and the like. Whether the CCA threshold is increased in a manner of an equal difference or a variable difference, a difference value is not limited in this embodiment. If that energy of a current channel exceeds the CCA threshold is detected, the sending node does not send data. If that energy of a current channel is lower than the CCA threshold is detected, the sending node performs channel contention. Therefore, after the CCA threshold is increased, if that energy of a current channel is lower than the increased CCA threshold is detected, the sending node is controlled to perform the parallel data transmission on the potential link. Even if the second system throughput is determined greater than the first system throughput, the sending node is controlled to still perform the serial data transmission on the potential link.

In an optional embodiment, when a node can be potential sending nodes of multiple potential links, whether a second system throughput during parallel data transmission on each potential link is greater than a first system throughput during serial data transmission on each potential link may be calculated in the foregoing manner. If a second system throughput during parallel data transmission on any potential link is greater than or equal to a first system throughput during serial data transmission on the potential link, parallel data transmission is performed on the potential link, and serial data transmission is performed on another potential link. If second system throughputs during parallel data transmission on multiple potential links are greater than or equal to first system throughputs during serial data transmission on the potential links, one of the potential links may be selected for the parallel data transmission, and serial data transmission is performed on another potential link.

It should be noted that the potential link and the existing links in this embodiment are data links in an entire transmission bandwidth, or the potential link and the existing links are data links in a transmission sub-bandwidth of an entire transmission bandwidth. When the potential link and the existing links are data links in a transmission sub-bandwidth of an entire transmission bandwidth, a format of the management frame broadcast by each node in the system in step 301 includes but is not limited to table 2.

TABLE 2

| | | | | |
|---|---|---|---|---|
| SINR_1 | I_N_1 | . . . | SINR_n | I_N_n |

n is a quantity of transmission sub-bandwidths of the entire transmission bandwidth, and n is not limited in this embodiment.

Whether the potential link and the existing links are data links in an entire transmission bandwidth, or data links in a transmission sub-bandwidth of an entire transmission bandwidth, the data transmission control method is consistent with the foregoing process, and details are not described again in this embodiment.

In addition, the first signal to interference plus noise ratio, the second signal to interference plus noise ratio, the first system throughput, and the second system throughput that are in this embodiment of the present application may be determined according to a sequence listed in the foregoing steps, or may be determined at the same time, or may be determined according to another sequence. This is not limited herein. The first and the second that occur in this embodiment of the present application are merely exemplary, and are not specific references.

According to the method provided in this embodiment of the present application, a first system throughput during serial data transmission performed by a sending node on a potential link and a second system throughput during parallel data transmission performed by the sending node on the potential link are calculated according to a first signal to interference plus noise ratio during the serial data transmission performed by the sending node on the potential link and a second signal to interference plus noise ratio during serial data transmission on each existing link that causes interference to the potential link, and then whether the sending node performs the parallel data transmission on the potential link is controlled according to the first system throughput and the second system throughput, thereby performing the parallel data transmission while ensuring a link throughput.

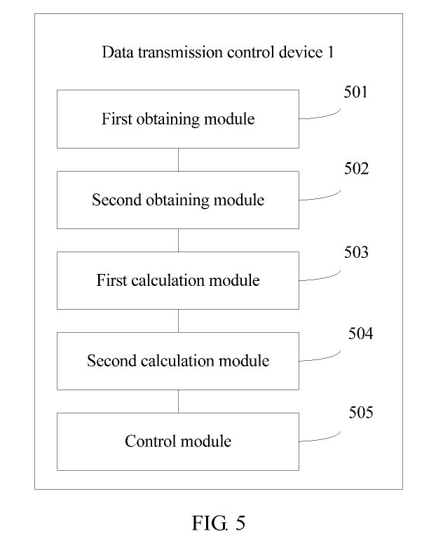

Another embodiment of the present application provides a data transmission control device 1, and the data transmission control device 1 is configured to execute the data transmission control method provided in the foregoing embodiment. As shown in FIG. 5, the data transmission control device 1 includes:

a first obtaining module 501, configured to obtain a first signal to interference plus noise ratio during serial data transmission performed by a sending node on a potential link;

a second obtaining module 502, configured to obtain a second signal to interference plus noise ratio during serial data transmission on each existing link that causes interference to the potential link;

a first calculation module 503, configured to calculate, according to the first signal to interference plus noise ratio and all the second signal to interference plus noise ratios, a first system throughput during the serial data transmission performed by the sending node on the potential link;

a second calculation module 504, configured to calculate, according to the first signal to interference plus noise ratio and all the second signal to interference plus noise ratios, a second system throughput during parallel data transmission performed by the sending node on the potential link; and

a control module 505, configured to control, according to the first system throughput and the second system throughput, whether the sending node performs the parallel data transmission on the potential link.

In an optional embodiment, the first obtaining module 501 is configured to obtain, according to a management frame broadcast by a potential receiving node on the potential link, the first signal to interference plus noise ratio during the serial data transmission performed by the sending node on the potential link.

The second obtaining module 502 is configured to obtain, according to a management frame broadcast by a receiving node on each existing link that causes interference to the potential link, the second signal to interference plus noise ratio during the serial data transmission on each existing link that causes interference to the potential link.

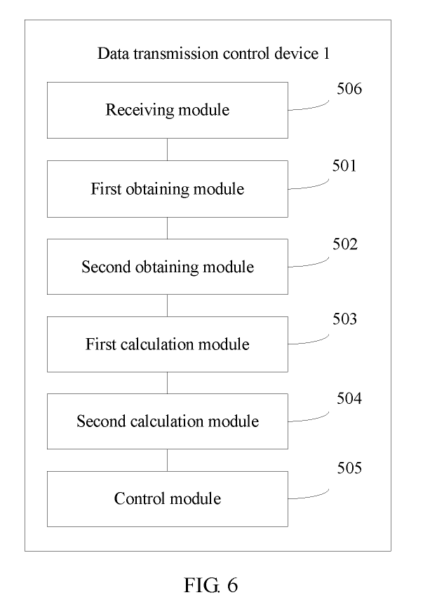

In an optional embodiment, referring to FIG. 6, the device further includes:

a receiving module 506, configured to receive, at preset time intervals, a management frame broadcast by each node in a system, where the management frame carries signal to interference plus noise ratio information of a link on which the node is located.

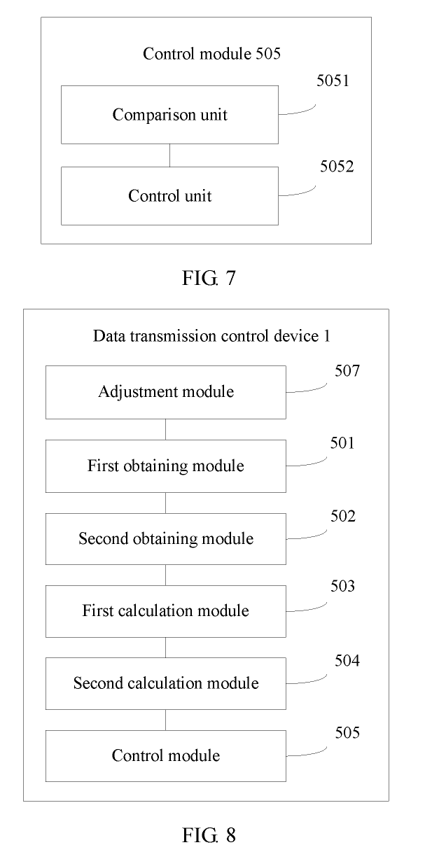

In an optional embodiment, referring to FIG. 7, the control module 505 includes:

a comparison unit 5051, configured to compare the first system throughput with the second system throughput; and

a control unit 5052, configured to control the sending node to perform the parallel data transmission on the potential link when the second system throughput is greater than the first system throughput.

In an optional embodiment, referring to FIG. 8, the device further includes:

an adjustment module 507, configured to increase a clear channel assessment threshold.

The control unit 5052 is configured to control the sending node to perform the parallel data transmission on the potential link when energy of a current channel is lower than an increased CCA threshold.

In an optional embodiment, the potential link and the existing links are data links in an entire transmission bandwidth, or the potential link and the existing links are data links in a transmission sub-bandwidth of an entire transmission bandwidth.

According to the data transmission control device provided in this embodiment of the present application, a first system throughput during serial data transmission performed by a sending node on a potential link and a second system throughput during parallel data transmission performed by the sending node on the potential link are calculated according to a first signal to interference plus noise ratio during the serial data transmission performed by the sending node on the potential link and a second signal to interference plus noise ratio during serial data transmission on each existing link that causes interference to the potential link, and then whether the sending node performs the parallel data transmission on the potential link is controlled according to the first system throughput and the second system throughput, thereby performing the parallel data transmission while ensuring a link throughput.

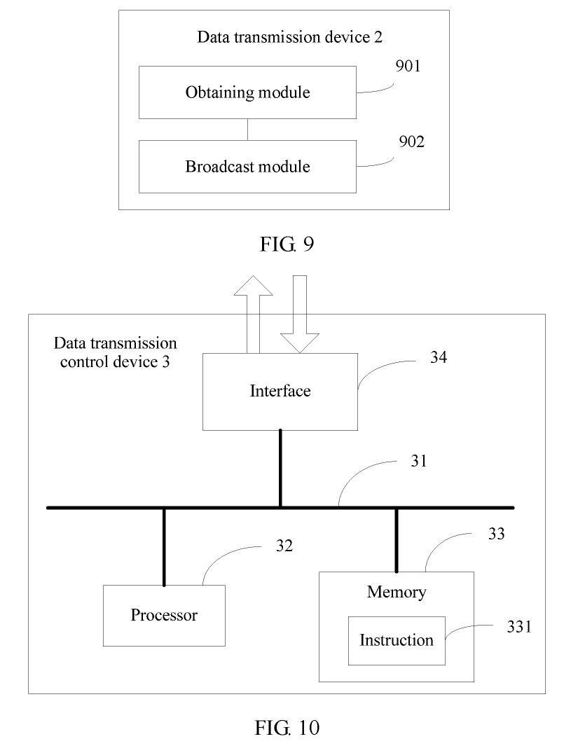

Another embodiment of the present application provides a data transmission device 2, and the data transmission device 2 is configured to execute functions executed by the receiving node in the foregoing data transmission control method. As shown in FIG. 9, the data transmission device 2 includes:

an obtaining module 901, configured to obtain a signal to interference plus noise ratio during serial data transmission on an existing link; and

a broadcast module 902, configured to broadcast a management frame in a preset cycle, where the management frame carries the signal to interference plus noise ratio during the serial data transmission on the existing link, so that a data transmission control device controls, according to the signal to interference plus noise ratio carried in the management frame, whether the sending node performs parallel data transmission on the potential link.

In an optional embodiment, the potential link and the existing link are data links in an entire transmission bandwidth, or the potential link and the existing link are data links in a transmission sub-bandwidth of an entire transmission bandwidth.

According to the data transmission device provided in this embodiment of the present application, a management frame carrying a signal to interference plus noise ratio during serial data transmission on an existing link is broadcast in a preset cycle, so that the data transmission device calculates, according to a first signal to interference plus noise ratio during serial data transmission performed by a sending node on a potential link and a second signal to interference plus noise ratio during serial data transmission on each existing link that causes interference to the potential link, a first system throughput during the serial data transmission performed by the sending node on the potential link and a second system throughput during parallel data transmission performed by the sending node on the potential link, and then whether the sending node performs the parallel data transmission on the potential link is controlled according to the first system throughput and the second system throughput, thereby performing the parallel data transmission while ensuring a link throughput.

Another embodiment of the present application provides a data transmission control device 3. As shown in FIG. 10, the data transmission control device 3 includes: a bus 31, a processor 32, a memory 33, and an interface 34. The processor 32, the memory 33, and the interface 34 are connected to the bus 31. The interface 34 is configured to communicate with another network element. The memory 33 is configured to store an instruction 331. The processor 32 executes the instruction 331 to: obtain a first signal to interference plus noise ratio during serial data transmission performed by a sending node on a potential link, and obtain a second signal to interference plus noise ratio during serial data transmission on each existing link that causes interference to the potential link; calculate, according to the first signal to interference plus noise ratio and all the second signal to interference plus noise ratios, a first system throughput during the serial data transmission performed by the sending node on the potential link, and calculate, according to the first signal to interference plus noise ratio and all the second signal to interference plus noise ratios, a second system throughput during parallel data transmission performed by the sending node on the potential link; and control, according to the first system throughput and the second system throughput, whether the sending node performs the parallel data transmission on the potential link.

In an optional embodiment, when executing the instruction 331 to obtain the first signal to interference plus noise ratio during the serial data transmission performed by the sending node on the potential link, the processor 32 is configured to obtain, according to a management frame broadcast by a potential receiving node on the potential link, the first signal to interference plus noise ratio during the serial data transmission performed by the sending node on the potential link.

When executing the instruction 331 to obtain the second signal to interference plus noise ratio during the serial data transmission on each existing link that causes interference to the potential link, the processor 32 is configured to obtain, according to a management frame broadcast by a receiving node on each existing link that causes interference to the potential link, the second signal to interference plus noise ratio during the serial data transmission on each existing link that causes interference to the potential link.

In an optional embodiment, the processor 32 executes the instruction 331 to receive, at preset time intervals, a management frame broadcast by each node in a system, where the management frame carries signal to interference plus noise ratio information of a link on which the node is located.

In an optional embodiment, the processor 32 executes the instruction 331 to: compare the first system throughput with the second system throughput; and control the sending node to perform the parallel data transmission on the potential link if the second system throughput is greater than the first system throughput.

In an optional embodiment, the processor 32 executes the instruction 331 to increase a clear channel assessment threshold.

In an optional embodiment, the potential link and the existing links that occur in this embodiment are data links in an entire transmission bandwidth, or the potential link and the existing links are data links in a transmission sub-bandwidth of an entire transmission bandwidth.

According to the data transmission control device provided in this embodiment of the present application, a first system throughput during serial data transmission performed by a sending node on a potential link and a second system throughput during parallel data transmission performed by the sending node on the potential link are calculated according to a first signal to interference plus noise ratio during the serial data transmission performed by the sending node on the potential link and a second signal to interference plus noise ratio during serial data transmission on each existing link that causes interference to the potential link, and then whether the sending node performs the parallel data transmission on the potential link is controlled according to the first system throughput and the second system throughput, thereby performing the parallel data transmission while ensuring a link throughput.

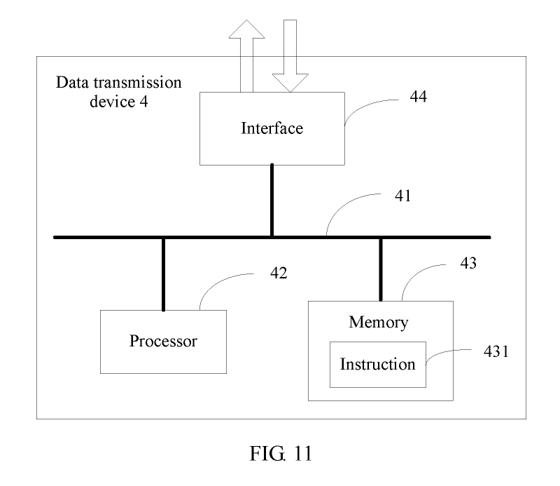

Another embodiment of the present application provides a data transmission device 4. As shown in FIG. 11, the data transmission device 4 includes: a bus 41, a processor 42, a memory 43, and an interface 44. The processor 42, the memory 43, and the interface 44 are connected to the bus 41. The interface 44 is configured to communicate with another network element. The memory 43 is configured to store an instruction 431. The processor 42 executes the instruction 431 to: obtain a signal to interference plus noise ratio during serial data transmission on an existing link; and broadcast a management frame in a preset cycle, where the management frame carries the signal to interference plus noise ratio during the serial data transmission on the existing link, so that a data transmission control device controls, according to the signal to interference plus noise ratio carried in the management frame, whether the sending node performs parallel data transmission on the potential link.

In an optional embodiment, the potential link and the existing link that occur in this embodiment are data links in an entire transmission bandwidth, or the potential link and the existing link are data links in a transmission sub-bandwidth of an entire transmission bandwidth.

According to the data transmission device provided in this embodiment of the present application, a management frame carrying a signal to interference plus noise ratio during serial data transmission on an existing link is broadcast in a preset cycle, so that the data transmission device calculates, according to a first signal to interference plus noise ratio during serial data transmission performed by a sending node on a potential link and a second signal to interference plus noise ratio during serial data transmission on each existing link that causes interference to the potential link, a first system throughput during the serial data transmission performed by the sending node on the potential link and a second system throughput during parallel data transmission performed by the sending node on the potential link, and then whether the sending node performs the parallel data transmission on the potential link is controlled according to the first system throughput and the second system throughput, thereby performing the parallel data transmission while ensuring a link throughput.

It should be noted that division of the foregoing function modules is merely used as an example for description when the data transmission control device and the data transmission device that are provided in the foregoing embodiments control data transmission. In actual application, the foregoing functions may be allocated, according to a requirement, to different function modules for completion, that is, the devices are divided into different function modules to complete all or a part of the functions described above. In addition, the data transmission control device and the data transmission device that are provided in the foregoing embodiments pertain to a same concept as the embodiment of the data transmission control method. For specific implementation processes of the devices, refer to the method embodiment. Details are not described herein again.

The sequence numbers of the foregoing embodiments of the present application are merely for illustrative purposes, and are not intended to indicate priorities of the embodiments.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present application, but are not intended to limit the present application. Any modification, equivalent replacement, and improvement made without departing from the spirit and principle of the present application shall fall within the protection scope of the present application.

What is claimed is:

1. A data transmission control method comprising:
obtaining a first signal to interference plus noise ratio (SINR) during serial data transmission performed by a sending node on a potential link, and obtaining a second SINR during serial data transmission on each existing link that causes interference to the potential link;
calculating, according to the first SINR and all the second SINRs, a first system throughput during the serial data transmission performed by the sending node on the potential link, and calculating, according to the first SINR and all the second SINRs, a second system throughput during parallel data transmission performed by the sending node on the potential link; and
controlling, based on the first system throughput and the second system throughput, whether the sending node performs the parallel data transmission on the potential link.

2. The method according to claim 1, wherein the obtaining a first SINR during serial data transmission performed by a sending node on a potential link comprises:
obtaining, from a management frame broadcast by a potential receiving node on the potential link, the first SINR during the serial data transmission performed by the sending node on the potential link; and
the obtaining a second SINR during serial data transmission on each existing link that causes interference to the potential link comprises:
obtaining, from a management frame broadcast by a receiving node on each existing link that causes interference to the potential link, the second SINR during the serial data transmission on each existing link that causes interference to the potential link.

3. The method according to claim 2, wherein the method further comprises:
receiving, at preset time intervals, a management frame broadcast by each node in a system, wherein the management frame carries SINR information of a link on which the node is located.

4. The method according to claim 1, wherein the controlling, based on the first system throughput and the second system throughput, whether the sending node performs the parallel data transmission on the potential link comprises:
comparing the first system throughput with the second system throughput; and
controlling the sending node to perform the parallel data transmission on the potential link if the second system throughput is greater than the first system throughput.

5. The method according to claim 4, wherein if the second system throughput is greater than the first system throughput, the method further comprises:
increasing a clear channel assessment(CCA) threshold; and
the controlling the sending node to perform the parallel data transmission on the potential link comprises:
controlling the sending node to perform the parallel data transmission on the potential link if energy of a current channel is lower than an increased CCA threshold.

6. The method according to claim 1, wherein the potential link and the existing links are data links in an entire transmission bandwidth, or the potential link and the existing links are data links in a transmission sub-bandwidth of an entire transmission bandwidth.

7. A data transmission control method comprising:
obtaining a SINR during serial data transmission on an existing link; and
broadcasting a management frame in a preset cycle, wherein the management frame carries the SINR during the serial data transmission on the existing link.

8. The method according to claim 7, wherein the potential link and the existing link are data links in an entire transmission bandwidth, or the potential link and the existing link are data links in a transmission sub-bandwidth of an entire transmission bandwidth.

9. A data transmission control device, comprising:
a first obtaining module, configured to obtain a first SINR during serial data transmission performed by a sending node on a potential link;
a second obtaining module, configured to obtain a second SINR during serial data transmission on each existing link that causes interference to the potential link;
a first calculation module, configured to calculate, based on the first SINR and all the second SINRs, a first system throughput during the serial data transmission performed by the sending node on the potential link;
a second calculation module, configured to calculate, according to the first SINR and all the second SINRs, a second system throughput during parallel data transmission performed by the sending node on the potential link; and
a control module, configured to control, based on the first system throughput and the second system throughput, whether the sending node performs the parallel data transmission on the potential link.

10. The device according to claim 9, wherein the first obtaining module is configured to obtain, from a management frame broadcast by a potential receiving node on the potential link, the first SINR during the serial data transmission performed by the sending node on the potential link; and
the second obtaining module is configured to obtain, from a management frame broadcast by a receiving node on each existing link that causes interference to the potential link, the second SINR during the serial data transmission on each existing link that causes interference to the potential link.

11. The device according to claim 10, wherein the device further comprises:
a receiving module, configured to receive, at preset time intervals, a management frame broadcast by each node in a system, wherein the management frame carries SINR information of a link on which the node is located.

12. The device according to claim 9, wherein the control module comprises:
a comparison unit, configured to compare the first system throughput with the second system throughput; and
a control unit, configured to control the sending node to perform the parallel data transmission on the potential link when the second system throughput is greater than the first system throughput.

13. The device according to claim 12, wherein the device further comprises:
an adjustment module, configured to increase a clear channel assessment(CCA) threshold; and
the control unit is configured to control the sending node to perform the parallel data transmission on the potential link when energy of a current channel is lower than an increased CCA threshold.

14. The device according to claim 9, wherein the potential link and the existing links are data links in an entire transmission bandwidth, or the potential link and the existing links are data links in a transmission sub-bandwidth of an entire transmission bandwidth.

15. A data transmission device comprising:
an obtaining module, configured to obtain a SINR during serial data transmission on an existing link; and
a broadcast module, configured to broadcast a management frame in a preset cycle, wherein the management frame carries the SINR during the serial data transmission on the existing link.

16. The device according to claim 15, wherein the potential link and the existing link are data links in an entire transmission bandwidth, or the potential link and the existing link are data links in a transmission sub-bandwidth of an entire transmission bandwidth.

17. A device, comprising:
a processor; and
a non-transitory computer-readable storage medium coupled to the processor and storing programming instructions for execution by the processor, the programming instructions instruct the processor to:
obtain a first signal to interference plus noise ratio (SINR) during serial data transmission performed by a sending node on a potential link, and obtaining a second SINR during serial data transmission on each existing link that causes interference to the potential link;
calculate, according to the first SINR and all the second SINRs, a first system throughput during the serial data transmission performed by the sending node on the potential link, and calculating, according to the first SINR and all the second SINRs, a second system throughput during parallel data transmission performed by the sending node on the potential link; and
control, based on the first system throughput and the second system throughput, whether the sending node performs the parallel data transmission on the potential link.

18. A device, comprising:
a processor; and
a non-transitory computer-readable storage medium coupled to the processor and storing programming instructions for execution by the processor, the programming instructions instruct the processor to:
obtain a SINR during serial data transmission on an existing link; and
broadcast a management frame in a preset cycle, wherein the management frame carries the SINR during the serial data transmission on the existing link.
